(19) United States
(12) Patent Application Publication
(10) Pub. No.: US 2005/0062875 A1
(43) Pub. Date: Mar. 24, 2005

(54) Image pickup apparatus

(76) Inventor: Noriaki Ojima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/909,397

(22) Filed: Aug. 3, 2004

(30) Foreign Application Priority Data
Aug. 8, 2003 (JP) 2003-290964

(51) Int. Cl. H04N 5/235

(52) U.S. Cl. 348/362

(57) ABSTRACT

An image pickup apparatus comprising a scene-photographing mode selection switch configured for switchingly enable photographing suitable for a scene to be photographed, and an exposure adjuster configured for adjusting an exposure amount, wherein a scale graduation of an exposure-adjusting amounts to be adjusted by said exposure adjuster nay be adjustable independently depending upon respective scene-photographing modes.

### BACKGROUND OF THE INVENTION

1. Field of the Invention

The present invention relates to an image pickup apparatus comprising a scene-photographing mode selection switch configured to switchingly enable photographing suitable for a scene to be photographed, and an exposure adjuster configured for adjusting an exposure amount. The Invention also relates to an image pickup apparatus having an exposure automatic exposure bracketing function for photographing a plurality of images, while changing the exposure amount.

2. Related Art Statement

Heretofore, in order to perform the automatic exposure control suitable for scenes to be photographed, means is known to automatically select the light-measuring system by varying a weighed amount for a area to be photographed depending upon a scene-photographing mode. See JP-A 2000-354196, for example.

However, since the camera measures a light reflected from an object to be photographed, the reflectance of the object largely influences the light measurement result. When the object having the reflectance near to the standard one is to be photographed, an appropriate exposure amount can be obtained. On the other hand, if the object has a higher reflectance, the exposure amount is insufficient (under exposure), whereas if it has a lower reflectance, the exposure amount becomes excessive (over exposure).

Since this problem is originated from an operational principle that the light reflected from the object to be photographed is measured, a fundamental solution cannot be realized even if the weighed amount for the area to be photographed is varied. Thus, it is indispensable to use an exposure adjusting function in which an exposure amount calculated by the automatic exposure is adjusted or the automatic exposure bracketing function in which a plurality of frames are photographed, while the exposure amount is varied little by little.

The above prior publication does not mention or consider the adjustment of the exposure amount. There is intimate relation between the scene to be photographed and the adjustment of the exposure amount. For example, with respect to a scale graduation in adjusting the exposure amount, suitable scale graduation differs between the landscape-photographing mode and the person-photographing mode.

A way of adjusting the exposure amount differs in that the landscape-photographing mode preferably adopts a method in which the exposure amount is varied by changing the shutter speed with the aperture fixed, whereas the sport-photographing mode preferably adopts a method in which the exposure amount is varied by changing the aperture with the shutter speed fixed.

However, it is actually difficult that an ordinary user who is not skilled in handling the camera makes an appropriate adjustment upon the exposure amount in the scene-photographing mode.

### SUMMARY OF THE INVENTION

The present invention has been accomplished in view of the above problems, and is to provide an image pickup apparatus which enables ordinary users being not skilled in handling cameras to make appropriate adjustment upon the exposure amount in case of the scene-photographing mode.

(First Aspect)

In order to solve the above problems and accomplished the above object, the image pickup apparatus according to the present invention comprises a scene-photographing mode selection switch configured for switchingly enable photographing suitable for a scene to be photographed, and an exposure adjuster configured for adjusting an exposure amount, wherein a scale graduation of an exposure-adjusting amounts to be adjusted by said exposure adjuster is adjustable independently for each of scene-photographing modes.

In the following, preferred embodiments of the first aspect of the image pickup apparatus according to the present invention will be recited. Any combinations of these embodiments are also preferred embodiments of the present invention, unless they are contrary to the invention.

### (1-1) PREFERRED EMBODIMENT 1-1

The scale graduation of the exposure-adjusting amount is preliminarily set to an optimum scale graduation for each of the scene-photographing modes.

### (1-2) PREFERRED EMBODIMENT 1-2

The scale graduations of the exposure-adjusting amounts for the respective scene-photographing modes are set to be independently optimized.

### (1-3) PREFERRED EMBODIMENT 1-3

A parameter for varying the exposure amount is set to an optimum parameter for each of the scene-photographing modes.

### (1-4) PREFERRED EMBODIMENT 1-4

The parameter for varying the exposure amount is selected from a shutter speed, an aperture and a photographing sensitivity, and the setting of the parameter to the optimum one for each of the scene-photographing modes means that exposure is adjusted such that while at least one of the exposure amount-varying parameters is fixed, the other is adjusted.

(Second Aspect)

As a second aspect of the present invention, there is provided an image pickup apparatus comprising a scene-photographing mode selection switch configured for switchingly enable photographing suitable for a scene to be photographed, and an exposure automatic exposure bracketing function effector configured for photographing a plurality of images while an exposure amount is being changed, wherein permission/inhibition of execution of the automatic exposure bracketing function effector is settable independently for scene-photographing modes.

In the following, preferred embodiments of the second aspect of the image pickup apparatus according to the present invention will be recited. Any combinations of these embodiments are also preferred embodiments of the present invention, unless they are contrary to the invention.

### (2-1) PREFERRED EMBODIMENT 2-1

A set parameter of an automatic exposure bracketing function is preliminarily set to a premium parameter for each of the scene-photographing modes.

### (2-2) PREFERRED EMBODIMENT 2-2

The set parameter of the automatic exposure bracketing function can be optimized independently for each of the scene-photographing modes.

### (2-3) PREFERRED EMBODIMENT 2-3

The set parameter of the automatic exposure bracketing function is a scale graduation of the exposure-adjusting amount.

### (2-4) PREFERRED EMBODIMENT 2-4

The set parameter of the automatic exposure bracketing function is a number of frames to be photographed while the exposure amount is being changed.

### (2-5) PREFERRED EMBODIMENT 2-5

The set parameter of the automatic exposure bracketing function is a standard exposure-adjusting amount.

### (2-6) PREFERRED EMBODIMENT 2-6

The set parameter of the automatic exposure bracketing function is an order of exposure adjustments.

### (2-7) PREFERRED EMBODIMENT 2-7

The parameter for varying the exposure amount is selected from a shutter speed, an aperture and a photographing sensitivity, and exposure is adjusted such that while at least one of the exposure amount-changing parameters is fixed, the other is adjusted.

According to the first aspect of the present invention, when the scale graduations of the exposure-adjusting amounts are adjustable independently for each of scene-photographing modes such that the exposure is adjusted to a plus side in a certain scene-photographing mode and no exposure adjusting is effected in another scene-photographing mode, the exposure-adjusting amount needs not be reset again every switching the scene-photographing mode. Consequently, a problem that the photographing is effected in a not intended set state of the exposure amount can be prevented. Thus, even an ordinary user who is not skilled in handling cameras can effect adjustment of the exposure amount to an optimum level for the scene-photographing mode.

According to the preferred embodiment (1-1) of the present invention, an effect of adjusting the exposure does not readily appear in the case of a landscape-photographing mode, for example, unless large exposure adjustment is effected with every scale graduation of 1.0 EV in adjusting the exposure, whereas an effect of adjusting the exposure is sufficient in the case of a person-photographing mode if small exposure adjustment is effected with every scale graduation of 0.3 EV in adjusting the exposure. Thus, when the optimum scale graduation is preliminarily set for each of the scene-photographing modes, usability of the image pickup apparatus is improved.

According to the preferred embodiment (1-2) of the present invention, although an adjustment amount of 0.5 EV may be ordinarily considered suitable for a certain scene-photographing mode, an appropriate adjustment amount may slightly differ depending upon photographer's preference. If the photographer prefers a darker image, 0.3 EV is more suitable in the above scene-photographing mode. If the photographer prefers a lighter image, 0.7 EV is more suitable in the above scene-photographing mode. Therefore, usability of the image pickup apparatus is improved in the above case if the photographer can set the scale graduation of the exposure-adjusting amount every scene-photographing mode depending upon his or her preference.

According to the preferred embodiment (1-3) of the present invention, usability of the image pickup apparatus is improved by setting the parameter for varying the exposure amount to an optimum parameter for each of the scene-photographing modes.

According to the preferred embodiment (1-4) of the present invention, the parameter for varying the exposure amount is selected from a shutter speed, an aperture and a photographing sensitivity, and the setting of the parameter to the optimum one for each of the scene-photographing modes means that exposure is adjusted such that while at least one of the exposure amount-varying parameters is fixed, the other is adjusted. For example, a way of fixing the aperture in adjusting the exposure amount is suitable in the mode of photographing the landscape scenes, whereas a way of fixing the shutter speed in adjusting the exposure amount is suitable in the mode of photographing the sport scenes. Therefore, usability of the image pickup apparatus is improved if the optimum parameter is set each of the scene-photographing modes.

According to the second aspect of the present invention, permission/inhibition of execution of the automatic exposure bracketing function effector is set independently for each of the scene-photographing modes such that the automatic exposure bracket-photographing is effected in a certain scene-photographing mode, whereas no automatic exposure bracket-photographing is effected in a certain scene-photographing mode. Thereby, it is unnecessary to reset the permission/inhibition of the execution of the automatic exposure bracketing function every time when the scene-photographing mode is switched, so that the problem that photographing is performed while no intended permission/inhibition of the execution of the automatic exposure bracketing function is kept can be prevented.

According to the preferred embodiment 2-1 of the present invention, since the set parameter of the automatic exposure bracketing function is preliminarily set to a premium parameter for each of the scene-photographing modes, the usability of the image pickup apparatus is improved.

According to the preferred embodiment 2-2 of the present invention, since the set parameter of the automatic exposure bracketing function can be optimized independently for each of the scene-photographing modes, the usability of the image pickup apparatus is improved.

According to the preferred embodiment 2-3 of the present invention, since the set parameter of the automatic exposure bracketing function is a scale graduation of the exposure-adjusting amount, if the scale graduation of the exposure-adjusting amount in automatic exposure bracket-photographing is preliminarily set for each scene-photographing mode, it is no need to reset the scale graduation of the exposure-adjusting amount every time when the scene-photographing mode, which is convenient. Further, if the scale graduation of the exposure-adjusting amount is settable, it can cope with preference of a photographer.

According to the preferred embodiment 2-4 of the present invention, since the set parameter of the automatic exposure bracketing function is a number of frames to be photographed while the exposure amount is being changed, it is no need to reset the number of the frames to be photographed every time when the scene-photographing mode, if the frames are preliminarily set for each scene-photographing mode. This is convenient. Further, if the number of the frames to be photographed is settable, it can cope with a use state of a photographer.

According to the preferred embodiment 2-5 of the present invention, the set parameter of the automatic exposure bracketing function is a standard exposure-adjusting amount. The standard exposure-adjusting amount is generally ±0 EV in the automatic exposure bracket-photographing, and +0.3 EV may be taken as the standard exposure-adjustment amount depending upon the scene-photographing mode. If the standard exposure-adjusting amount is preliminarily set in automatic exposure bracket-photographing for each of the scene-bracket photographing modes, it is no need to reset the standard exposure-adjusting amount every time when the scene-photographing mode is switched. Further, if the standard-adjusting amount is settable, it can cope with the preference of the photographer.

According to the preferred embodiment 2-6 of the present invention, the set parameter of the automatic exposure bracketing function is an order of exposure adjustments. For example, when three frames are to be photographed, the order of the exposure adjustments is generally any one of standard ‘minus’ plus, minus ‘standard’ plus and plus ‘standard’ minus. If the order of the exposure adjustments is settable in automatic exposure bracket-photographing, it can cope with the preference of the photographer.

According to the preferred embodiment 2-7 of the present invention, the parameter for setting the automatic exposure bracketing function is the exposure amount-changing parameter, and exposure amount-changing parameter is selected from a shutter speed, an aperture and a photographing sensitivity, and the exposure is adjusted such that exposure is adjusted such that while at least one of the exposure amount-changing parameters is fixed, the other is adjusted. For example, the landscape-photographing mode preferably adopts a method in which the exposure amount is varied by changing the shutter speed with the aperture fixed, whereas the sport-photographing mode preferably adopts a method in which the exposure amount is varied by changing the aperture with the shutter speed fixed.

### BRIEF DESCRIPTION OF THE DRAWINGS

For a better understanding of the invention, reference is made to the attached drawings, wherein:

FIG. 1 is a top view of showing an external appearance of a digital camera as one embodiment of the image pickup apparatus according to the present invention.

FIG. 2 is a front view of the external appearance of the digital camera in FIG. 1.

FIG. 3 is a back view of the external appearance of the digital camera in FIG. 1.

FIG. 4 is a block diagram for schematically illustrating the structure of the digital camera as one embodiment of the image pickup apparatus of the present invention.

FIG. 5 is a flow chart for illustrating a way of setting an exposure-adjusting amount depending upon a scene-photographing mode.

FIG. 6 is a flow chart for illustrating an automatic exposure bracket-photographing method corresponding to a scene-photographing mode.

FIG. 7 is a view showing a first setting screen of exposure adjustment every scene-photographing mode.

FIG. 8 is a view showing a second setting screen of exposure adjustment every scene-photographing mode.

FIG. 9 is a view showing a third setting screen of exposure adjustment every scene-photographing mode.

FIG. 10 is a view showing a first automatic exposure bracket-setting screen every scene-photographing mode.

FIG. 11 is a view showing a second automatic exposure bracket-setting screen every scene-photographing mode.

FIG. 12 is a view showing a third automatic exposure bracket-setting screen every scene-photographing mode.

In the following, the best mode of the image pickup apparatus according to the present invention will be explained in detail with reference to the attached thereto. Same reference numerals are given to identical or similar parts or processing throughout the drawings so long as it is possible.

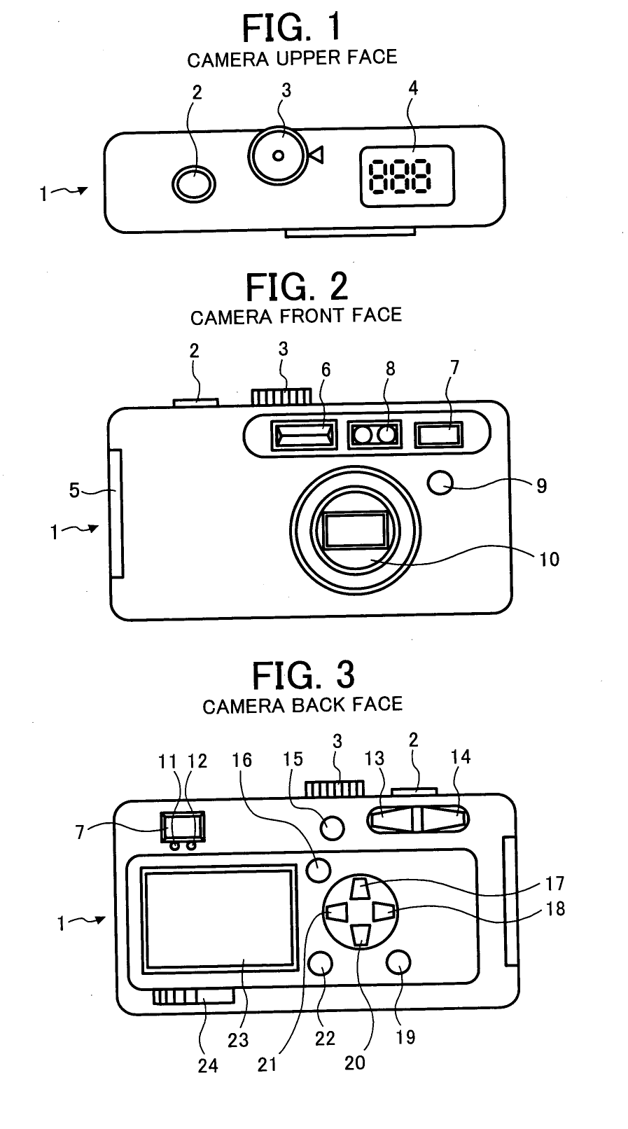

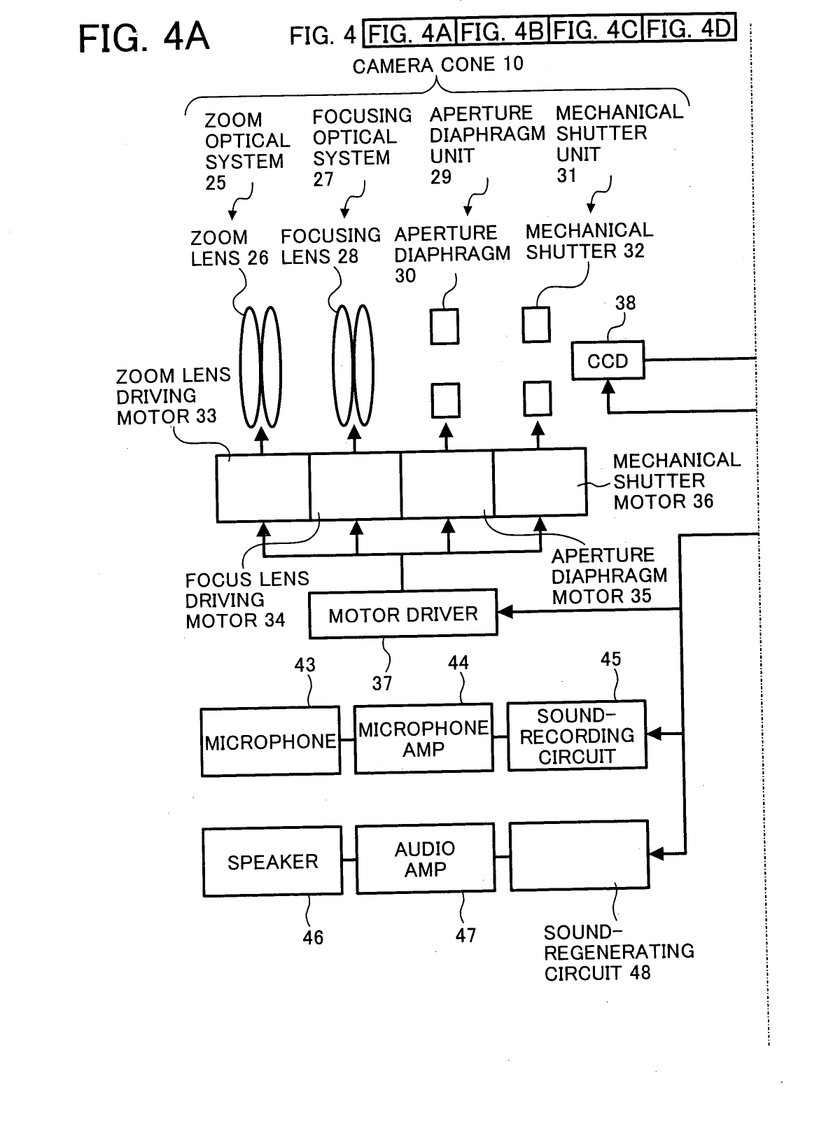

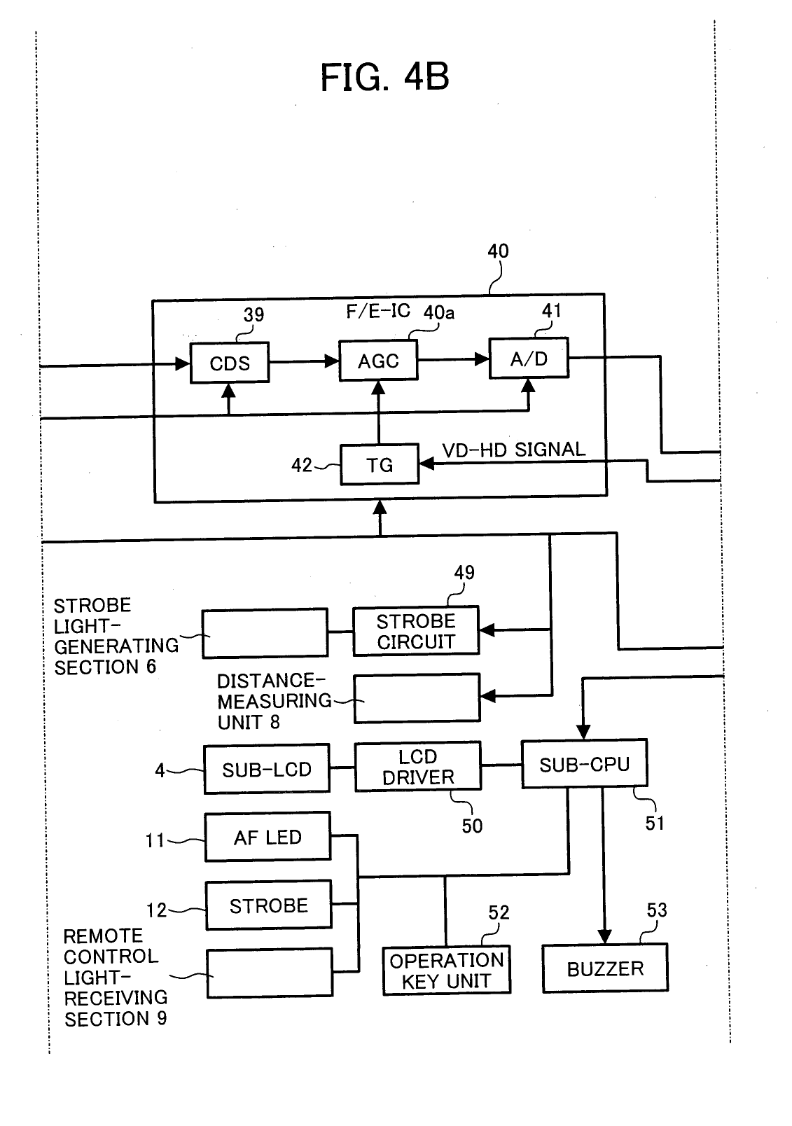

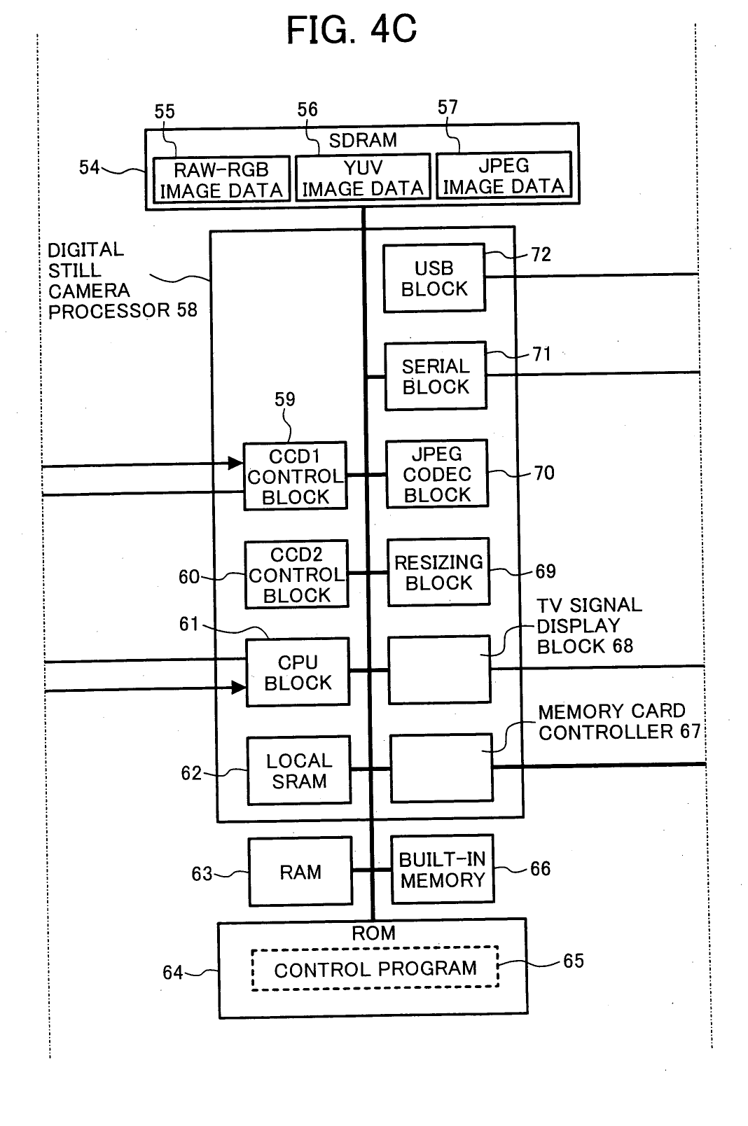

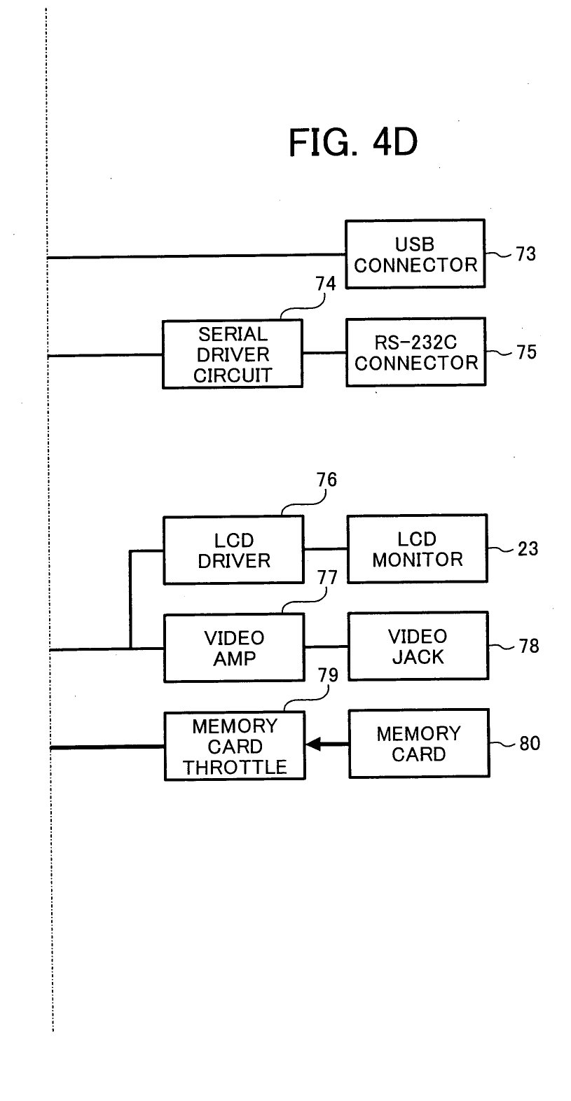

FIG. 1 is a top view of showing an external appearance of a digital camera as one embodiment of the image pickup apparatus according to the present invention. FIG. 2 is a front view of the external appearance of the digital camera in FIG. 1. FIG. 3 is a back view of the external appearance of the digital camera according to the present invention in FIG. 1. FIG. 4 is a block diagram for schematically illustrating the structure of the digital camera as one embodiment of the image pickup apparatus of the present invention. Now, the operation of the digital camera as one embodiment of the image pickup apparatus will be explained by using FIG. 1 to FIG. 4.

In FIG. 1 to FIG. 4, a release shutter (SW) 2, a mode dial (SW2) 3 and a SUB LCD 4 are arranged at an upper face of a digital camera body 1. At a front face of the digital camera body 1, there are arranged an SD card/cell lid 5, a strobe light emitter 6, an optical finder 7, a distance-measuring unit 8, a remote control light-receiving section 9 and a camera cone 10. At a back face of the digital camera body 1, there are arranged an AF LED 11, a strobe 12, a zoom switch (wide) (SW3) 13, a zoom switch (remote) (SW4) 14, a self timer/cancellation switch (SW5) 15, a menu switch (SW6) 16, and an upper strobe switch (SW7) 17. Further, at the back face of the digital camera body 1, there are arranged a right switch (SW8) 18, a display switch (SW9) 19, a lower strobe switch (SW10), a left image-confirming switch (SW11) 21, a lower okay switch (SW12) 22, a LCD monitor 23 and an electric power switch (SW13) 24.

In FIG. 4, the camera cone unit 10 comprises a zooming optical system 25 including zoom lenses 26 for taking in an optical image of an object to be photographed and a zooming motor 33, a focusing optical system 27 including focus lenses 28 and a focusing motor 34, an apparatus unit 29 including a mechanical shutter 32 and a mechanical shutter motor 36, and a motor driver 37 for driving various motors.

Operation of the motor driver 37 is controlled based on driving order from a CPU block 61 in a digital still camera processor 58 mentioned later, which is based on an input to the remote control light-receiving section 9 or an operation input to the operation key unit (SW1 to SW13) 52.

ROM 64 connected to the digital still camera processor 58 stores a control program 65 which is described in codes that may be read by a CPU block 61 as well as paragraphs to be controlled. When the digital camera is turned on, the above program is loaded into a main memory not shown, and the CPU block 61 controls the operation of each of the constituent parts of the apparatus according to that program. With this, data, etc. required for effecting controls are temporarily stored in a RAM 63 and a local SRAM 62 inside the digital still camera 58 mentioned later. If a rewritable flush ROM is used as the ROM 64, the control program and parameters can be modified to facilitate version up of the function in concern.

CCD 38 is a solid photographing element for effecting optoelectric conversion of optical images. An F/E (front/end)-IC40 comprises a CDS 39 for correlatively double sampling to remove image noise, AGC 40a for adjusting gains, an A/D converter 41 for effecting a digital signal conversion, and a TG 42 which receives vertically synchronized signals (hereinafter referred to as “VD”) and horizontally synchronized signals (hereinafter referred to as “HD) from a CCD 1 control block 59 and generates driving timing signals for the CCD 38 and the F/E-IC40 to be controlled by the CPU block 61.

The digital still camera processor 58 performs a white balance setting and a gamma setting for output data from the CCD38 via the F/E-IC40. As mentioned before, the processor 58 comprises the CCD1 control block 59 for feeding VD signals and HD signals to TG 42, the CCD2 control block 60 for effecting conversion to brightness data and color difference data by filtering, and the CPU block 61 for controlling the operations of the above-mentioned various constituent parts of the apparatus.

The digital still camera processor 58 comprises a local SRAM 62 for temporarily storing the data, etc. required to effect the above controlling, a USB block 72 for effecting USB communication between external devices such as a personal computer, a serial block 71 for effecting serial communication between external devices such as a personal computer, and a JPEG CODEC block 70 for effecting JPEG compression/expansion.

Further, the digital still camera processor 58 comprises a resizing block 69 for enlarging and shrinking sizes of image data by interpolation, a TV signal display block 68 for converting image data to video signals to be displayed in an external display device such as TV, and a memory card block 67 to control a memory card to record image data obtained by photographing.

A SDRAM 54 temporarily stores image data in variously processing the image data by means of the above digital still camera processor 58. The SDRAM 54 takes in those image data from the CCD 38 via the F/E-IC40. The image data received by the SDRAM 54 are “RAW-RGB image data” in which the white balance setting or the gamma setting were effected by the CCD1 (signal processing) control block 59, “YUV image data” in the state that the conversion of the brightness data and the color difference data is effected in the CCD2 control block 60, and “JPEG image data” in which. JPEG compression is effected in a JPEG CODEC block 70.

A memory card throttle 79 is a throttle into which a memory card 80 is detachably inserted. A built-in memory 66 is a memory which can store photographed image data when the memory card 80 is not fitted into the above memory card throttle 79.

An LCD driver 76 is a driving circuit for driving an LCD monitor 23 mentioned later, and also functions to convert video signals outputted from the TV signal display block to signals to be displayed in the LCD monitor 23. The LCD monitor 23 is a monitor to observe the state of a target object before photographing, confirm a photographed image, and display the image data recorded in the memory card 80 and the above built-in memory 66. A video AMP 77 is an amplifier to effect 75, impedance conversions of video signals outputted from the TV signal display block 68. A vide jack 78 is a jack for connection with an external display device such as TV.

A USB connector 73 is a connector for USB connection with an external device such as personal computer. A serial driver circuit 74 is a circuit to effect voltage conversion of output signals from the above serial block 71 so as to make communication between the external device such as the personal computer. An RS-232C connecter is a connecter for serial connection between the external device such as the personal computer.

A SUB-CPU 51 is a CPU having ROM and RAM built in a one chip, and outputs output signals of an operation key unit (SW1 to SW13) 52 and an operation key unit (SW1 to SW13) 52 or the remote control light-receiving section 9 as user operation information to the above-mentioned CPU block 61. The SUB-CPU 51 converts the state of the camera outputted from the above CPU block 61 to control signals for a SUB-LCD4, an AF LED 11, a strobe LED 12 and a buzzer 53 as mentioned below and outputs them.

The SUB-LCD 4 is a display for displaying the number of photographable frames, etc. An LCD driver 50 is a driving circuit for driving the SUB-LCD 4 based on a signal from the above SUB-CPU 51.

An AF LED 11 is an LED for displaying a focused state on photographing. The strobe LED 12 is a LED for displaying a charged state of the strobe. The AF LED 11 and the strobe LED 12 may be utilized for another display use indicating accessing to the memory card.

The operation key units (SW1 to SW13) 52 is a key circuit which a user operates, and the remote control light-receiving section 9 is a receiving section for a signal from a remote control transmitter operated by the user.

A sound-recording unit comprises a microphone 43 into which the user input audio signals, a microphone AMP 44 for amplifying audio signals inputted and an audio recording circuit 45 for recording the amplified audio signals. An audio reproducing unit comprises an audio reproducing circuit 48 for converting the recorded audio signals to signals to be outputted through a speaker, an audio AMP 47 for amplifying the converted audio signals and driving a speaker 46, and the speaker 46 for outputting the audio signals.

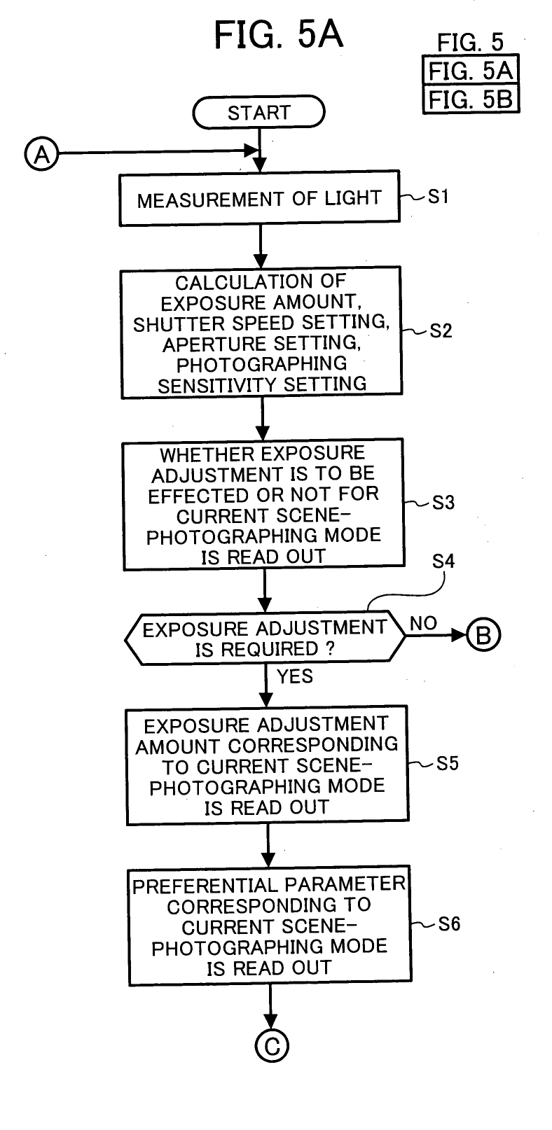

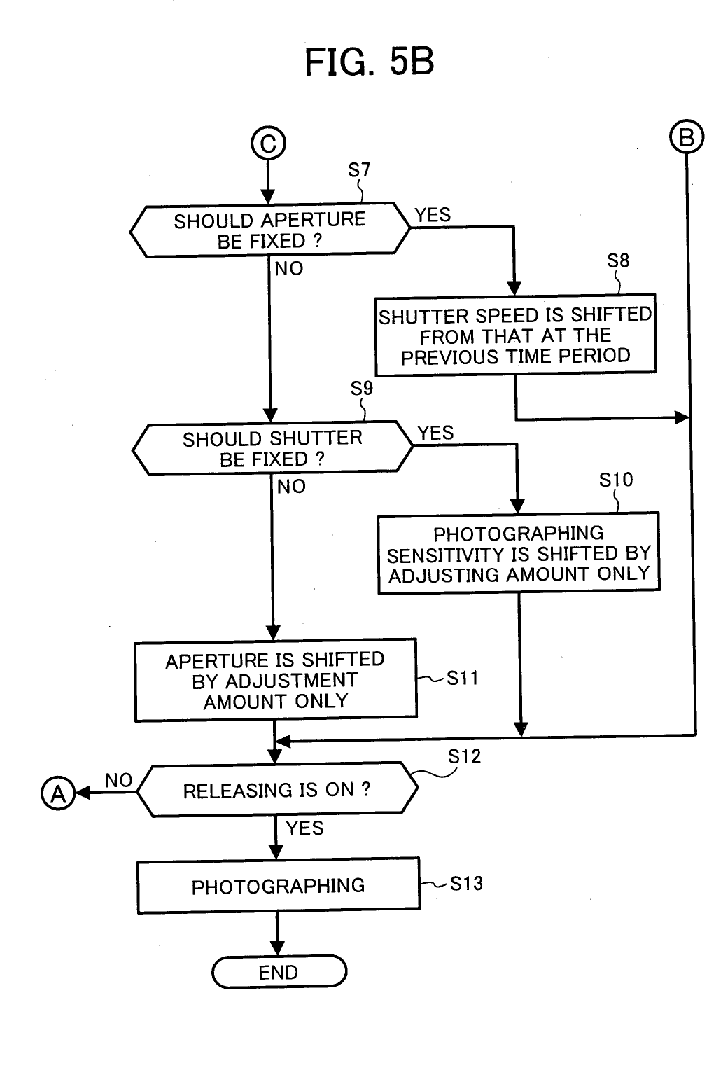

FIG. 5 is a flow chart for illustrating a way of setting an exposure-adjusting amount depending upon a scene-photographing mode. Next, with reference to FIG. 5, a way of setting the exposure-adjusting amount depending upon the scene-photographing mode will be explained. In FIG. 5, brightness of the object to be photographed is measured (S1). The measurement is effected by photoelectrically converting optical image data having passed through the camera barrel unit 10 shown in the camera block of FIG. 4 with the CCD 38, further converting the photoelectrically converted optical signals to digital data with the F/E-IC 40, and extracting a brightness signal component from the digital image data with the CCD1 control (signal processing) block 59 (S1).

Then, an exposure amount is calculated based on the brightness of the object obtained in S1, and a shutter speed, an aperture and a photographing sensitivity are set. The following equation 1 is met among BV: brightness of the object to be photographed, EV: exposure variable, TV: shutter speed, AV: aperture variable, and SV: sensitivity variable. The shutter speed, the aperture and the photographing sensitivity are determined based on this equation 1 (S2).
EV=BV+SV=TV+AV (Equation 1)

Next, whether exposure adjustment for a current scene-photographing mode is to be effected or not is read out (S3). Information whether exposure adjustment for the current scene-photographing mode is to be effected or not is stored in an area other than the image-recording area of the built-in memory 66 shown in the camera block diagram of FIG. 4. Further, in case the ROM 64 shown in the camera block diagram of FIG. 4 is a rewritable flash ROM, that information may be stored in an area other than that storing a control program of the ROM 64. Furthermore, an initial value as to whether exposure adjustment is to be effected or not for each of scene-photographing modes is set at an optimum value which a manufacturer thinks, but thereafter a user may change such an initial value. Operation for the user to make such change will be explained later. Next, it is judged as to whether or not data read out in S3 is to include exposure adjustment. If there is no exposure adjustment, proceed to S12. If exposure adjustment is required, proceed to S5. See S4.

Then, if the exposure is to be adjusted, an exposure-adjusting amount set corresponding to the current scene-photographing mode is read out. Memorization of the exposure-adjusting amount set corresponding to each scene-photographing mode is the same as in the judgment as to whether the exposure is to be adjusted or not in connection with S3. See S5.

Thereafter, an exposure adjustment-preferential parameter set corresponding to the current scene-photographing mode is read out. An exposure adjustment-preferential parameter set corresponding to each of the current scene-photographing mode is stored in the same manner as in the case of the judgment as to whether the exposure is to be adjusted or not in connection with S3. See S6.

Then, it is judged whether or not the exposure adjustment-preferential parameter is “fixed aperture”. If it is not of the “fixed aperture”, proceed to S9. If it is the “fixed aperture#, proceed to S8. See S7. If it is the “fixed aperture”, the shutter speed (TV) is shifted by an exposure-adjusting amount. A control formula is expressed by the following equation (2) in which ΔEV is an exposure-adjusting amount, and ΔTV is a shift amount of the shutter speed corresponding to the exposure-adjusting amount (S8).
EV+ΔEV=BV+ΔEV=TV+ΔTV+AV−SV (Equation 2)

If the exposure adjustment-preferential parameter is not the “fixed aperture”, it is judged whether or not the aperture adjustment-preferential parameter is the “fixed shutter speed”. If the shutter speed is not fixed, proceed to S11. If it is of the shutter speed-fixed type, proceed to S10. See S9.

Next, if the shutter speed is fixed, the photographing sensitivity (SV) is shitted by the exposure-adjusting amount. A control formula is expressed by the following equation (3) in which ΔEV is an exposure-adjusting amount, and ΔSV is a shift amount of the photographing sensitivity corresponding to the exposure-adjusting amount (S10).
EV+ΔEV=BV+ΔEV=TV+AV−(SV+ΔSV) (Equation 3)

Thereafter, if the shutter speed is not fixed, the aperture (AV) is shitted by the exposure-adjusting amount. A control formula is expressed by the following equation 4 in which AEV is an exposure-adjusting amount, and ΔAV is the shift amount of the aperture corresponding to the exposure-adjusting amount (S11).
EV+ΔEV=BV+ΔEV=TV+(AV+ΔAV)−SV (Equation 4)

Then, whether the shutter release button is pushed down (turned on) or not is judged. If the button is not pushed down, operation is returned to S1, and processing from measurement of the brightness of the object to be photographed to the step at 11 is repeated. By so doing, the object to be photographed can be observed in a monitoring state, with the exposure adjustment effected, by use of the LCD monitor 23 of the camera outer view in FIGS. 1 to 3 and of the camera block diagram in FIG. 4. If the shutter release is pushed down, proceed to S13. See S12. Then, photographing is effected, and processing is terminated (S13).

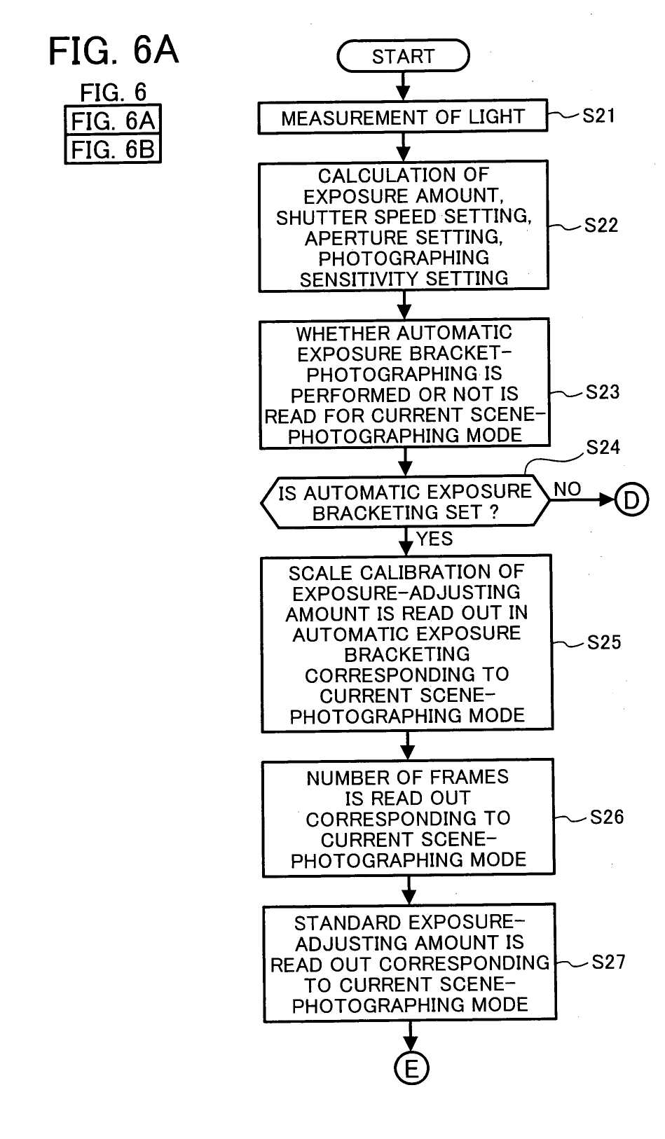

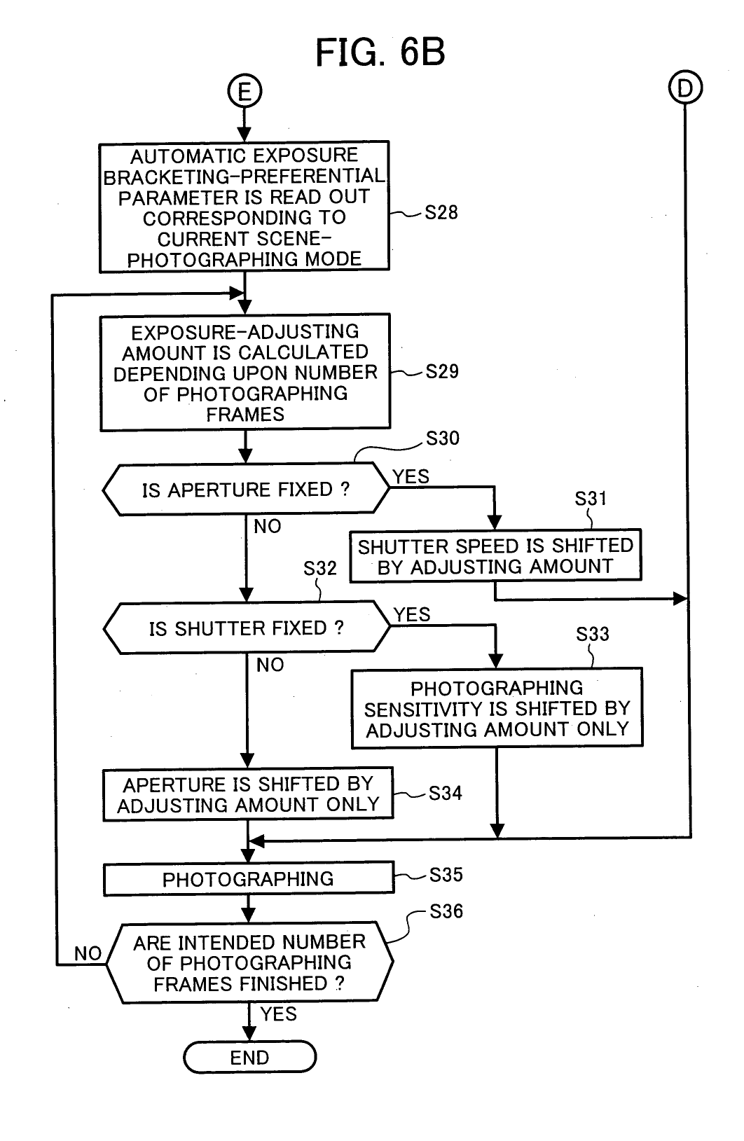

FIG. 6 is a flow chart for illustrating an automatic exposure bracket-photographing method corresponding to a scene-photographing mode. In FIG. 6, the automatic exposure bracket-photographing method corresponding to the scene-photographing mode will be explained. In FIG. 6, first the brightness of the object to be photographed is measured. The measurement may be explained in the same manner as in case of S1 in the exposure-adjusting method corresponding to the scene-photographing mode explained by using FIG. 5 (S21).

Next, the exposure amount is calculated from the brightness of the object obtained at S21, and the shutter speed, the aperture and the photographing sensitivity are set. They are set in the same manner as in S2 and the equation 1 in the exposure-adjusting method corresponding to the scene-photographing mode as explained by using FIG. 5.

Thereafter, it is read out whether or not the automatic exposure bracket-photographing is to be effected corresponding to the current scene-photographing mode (S23). Information as to whether the automatic exposure bracket-photographing is to be effected or not for each scene-photographing mode is stored in an area other than the image-recording area of the built-in memory 66 shown in the block diagram of FIG. 4. Further, in case the ROM64 shown in the camera block diagram of FIG. 4 is a rewritable flash ROM, that information may be stored in an area other than that storing the control program of the ROM 64. Furthermore, an initial value as to whether the automatic exposure bracket-photographing is to be effected or not for each of scene-photographing modes is set at an optimum value which a manufacturer thinks, but thereafter a user may change such an initial value. Operation for the user to make such change will be explained later.

Next, it is judged whether setting of the automatic exposure bracket-photographing read out in Step 23 requires the automatic exposure bracket-photographing or not (Step 24). If no automatic exposure bracket-photographing is required, proceed to S35. If the automatic exposure bracket-photographing is required, proceed to S25.

If the automatic exposure bracket-photographing is required, a scale graduation of the exposure-adjusting amount on the automatic exposure bracket-photographing set corresponding to the current scene-photographing mode is read out. Storage of the scale graduation of the exposure-adjusting amount on automatic exposure bracket-photographing set corresponding to each scene-photographing mode is done in the same manner as in the case of setting the automatic exposure bracket-photographing explained at S23. See S25.

Next, the intended number of the photographing frames on automatic exposure bracket-photographing set corresponding to the current scene-photographing mode is read out. Storage of the number of the photographing frames on automatic exposure bracket-photographing set corresponding to each scene-photographing mode may be done in the same manner as in the case of setting the automatic exposure bracket-photographing explained at S23. See S26.

Then, a standard exposure-adjusting amount on automatic exposure bracket-photographing set corresponding to the current scene-photographing mode is read out. Storage of the standard exposure-adjusting amount on automatic exposure bracket-photographing set corresponding to each scene-photographing mode may be done in the same manner as in the case of setting the automatic exposure bracket-photographing at S23. See S27.

Thereafter, the automatic exposure bracket-photographing-preferential parameter set corresponding to the current scene-photographing mode is read out. Storage of the preferential parameter on automatic exposure bracket-photographing set corresponding to each scene-photographing mode may be made in the same manner as in the case of setting the automatic exposure bracket-photographing explained at S23. See S28.

Then, an exposure-adjusting amount on photographing is calculated based on the number of photographing frames, the scale graduation of the exposure-adjusting amount and the standard exposure-adjusting amount on automatic exposure bracket-photographing (S29). For example, the automatic exposure bracket-photographing is effected with three frames, the scale graduation of the exposure-adjusting amount of 0.3 EV in the order of −0.3 EV, ±0 EV and +0.3 EV as well as the standard exposure-adjusting amount of 0.5 EV. In this case, if the number of frames photographed on the automatic exposure bracket-photographing is 0 (a first one is being photographed from now on), an exposure-adjusting amount will be −0.3 EV+0.5 EV=0.2 EV. If the number of frames photographed on the automatic exposure bracket-photographing is 2 (final third one is being photographed from now on), the exposure-adjusting amount is +0.3 EV+0.5 EV=0.8 EV.

Next, it is judged whether or not the exposure adjustment-preferential parameter is “fixed aperture”. If the parameter is not the “fixed aperture”, proceed to S32, whereas if the parameter is the “fixed aperture”, proceed to S31. See S30. In the case of the fixed aperture, the shutter speed (TV) is shifted by the exposure-adjusting amount. The relationship between the exposure-adjusting amount and the shift amount of the shutter speed corresponding to the exposure-adjusting amount is in the same manner as in S8 and the equation 2 in the exposure-adjusting method according to the scene-photographing mode as explained by using FIG. 5. See S31.

If the exposure adjustment-preferential parameter is not the “fixed aperture”, it is judged whether the parameter is the fixed shutter speed” or not. If the parameter is not the “fixed shutter speed”, proceed to S34. If the parameter is the fixed shutter speed, proceed to S33. See S32.

If the parameter is the “fixed shutter speed”, the photographing sensitivity (SV) is shifted by an exposure-adjusting amount. The relationship between the exposure-adjusting amount and the shift of the photographing sensitivity corresponding to the exposure-adjusting amount is the same as that in S10 and the equation 3 of the exposure-adjusting method corresponding to the scene-photographing mode as explained by using FIG. 5. If the parameter is not the “fixed shutter speed”, the aperture (AV) is shifted by an exposure-adjusting amount. The relationship between the exposure-adjusting amount and the shift of the aperture corresponding to the exposure-adjusting amount is the same as that in S11 and the equation 4 of the exposure-adjusting method corresponding to the scene-photographing mode as explained by using FIG. 3. See S34. Then, photographing is effected (S35).

Next, it is judged whether photographing of the intended number of frames in the automatic exposure bracket-photographing is finished or not (S36). If the photographing is not finished yet, the process is returned to S29 in which photographing is repeated, until the finishing of the photographing of the intended number of the frames. If photographing of the intended number of the frames is fined, the step is terminated.

It is possible to use the exposure adjustment and the automatic exposure bracket-photographing every scene-photographing mode in combination. In this case, the processes from S23 to S36 in the flow chart of FIG. 6 are performed in the photographing S13 in the flow chart of FIG. 5. At that time, since processes in S21 and S22 are performed in S1 and S2, S21 and S22 need not to be repeated again.

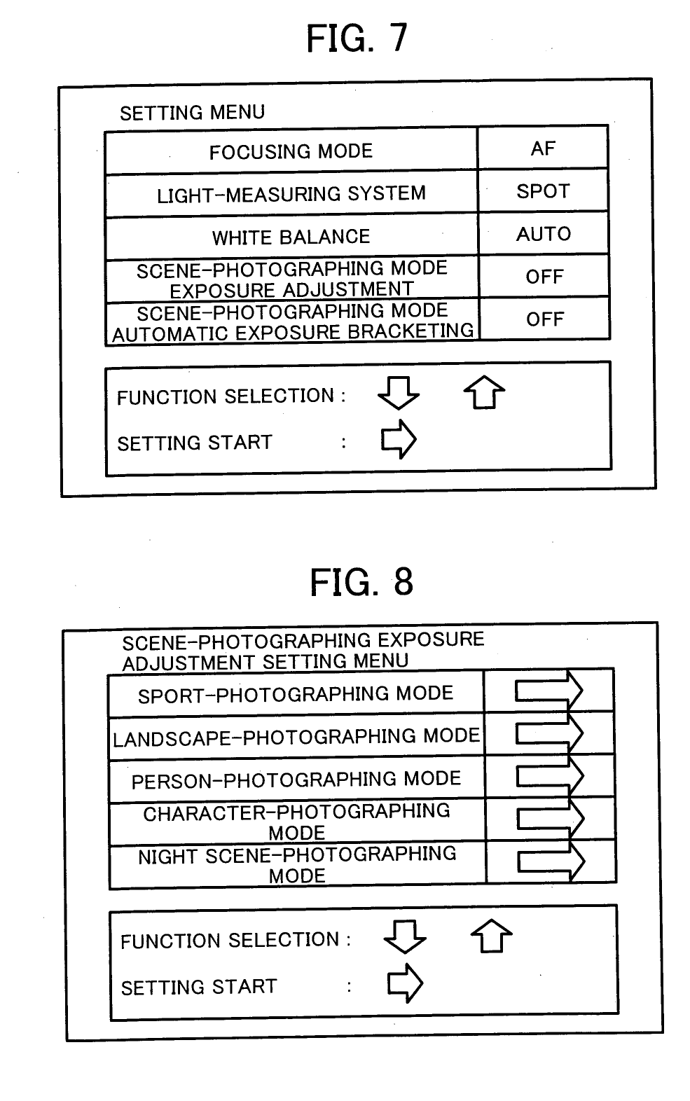

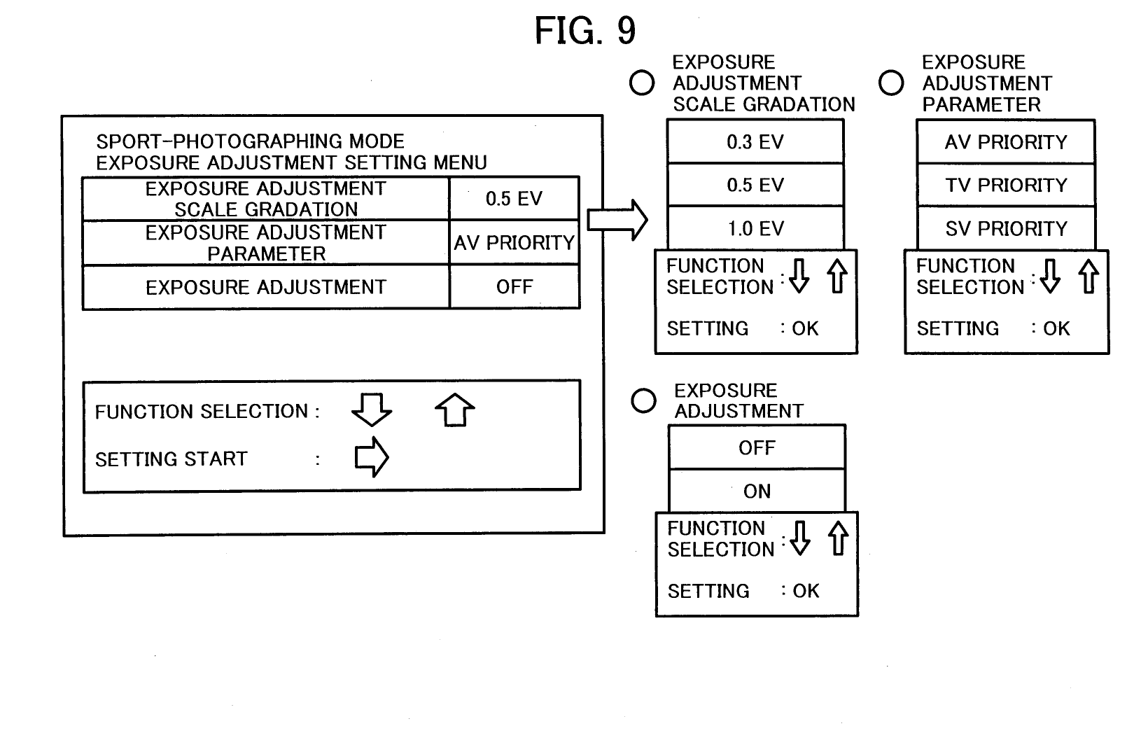

Next, the exposure adjustment-setting method every scene-photographing mode will be explained by using FIGS. 7 to 8. FIG. 7 is a view showing a first setting screen of exposure adjustment every scene-photographing mode. FIG. 8 is a view showing a second setting screen of exposure adjustment every scene-photographing mode. FIG. 9 is a view showing a third setting screen of exposure adjustment every scene-photographing mode.

When the mode dial (SW2) 3 of the external view of the camera in FIG. 1 is set to a setup position, the screen for setting camera operations shown in the exposure adjustment setting screen every the scene-photographing mode in FIG. 7 is displayed. The setting screen may be displayed by pushing down the menu switch (SW6) 16 in the state that the mode dial (SW2) 3 is set to the photographing position. Then, scene mode exposure adjustment is selected by using the upper strobe switch (SW7) 17 and the lower macroswitch (SW10) 20 in the external view of the camera in FIG. 3, and when the right switch (SW8) 18 is pushed down, the exposure adjustment setting screen 2 every scene-photographing mode in FIG. 8 is displayed.

Next, the scene-photographing mode is selected in the exposure adjustment setting screen every scene-photographing mode in FIG. 8 by using the upper strobe switch (SW7) 17 and the lower macroswitch (SW10) 20 in the external view of the camera in FIG. 3, and when the right switch (SW8) 18 is pushed down, the exposure adjustment setting screen every photographing mode in FIG. 9 is displayed.

Then, the currently set state of each set item is displayed in the exposure adjustment setting screen every scene-photographing mode in FIG. 8. If a user does not change the setting, it goes without saying that the initial value set by the maker is displayed.

Next, an item desired to be set is selected in the exposure adjustment setting screen every scene-photographing mode in FIG. 9 by using the upper strobe switch (SW7) 17 and the lower macroswitch (SW10) 20 in the external view of the camera in FIG. 3, and when the right switch (SW8) 18 in the external view of the camera in FIG. 3 is pushed down, set values for set items shown right to the exposure adjustment setting screen every photographing mode in FIG. 9 are displayed.

Next, a desired set value is selected by using the upper strobe switch (SW7) 17 and the lower macroswitch (SW10) 20 in the external view of the camera in FIG. 3, and when the okay switch (SW12) 22 in the external view of the camera in FIG. 3 is pushed down, the desired set value is finally selected.

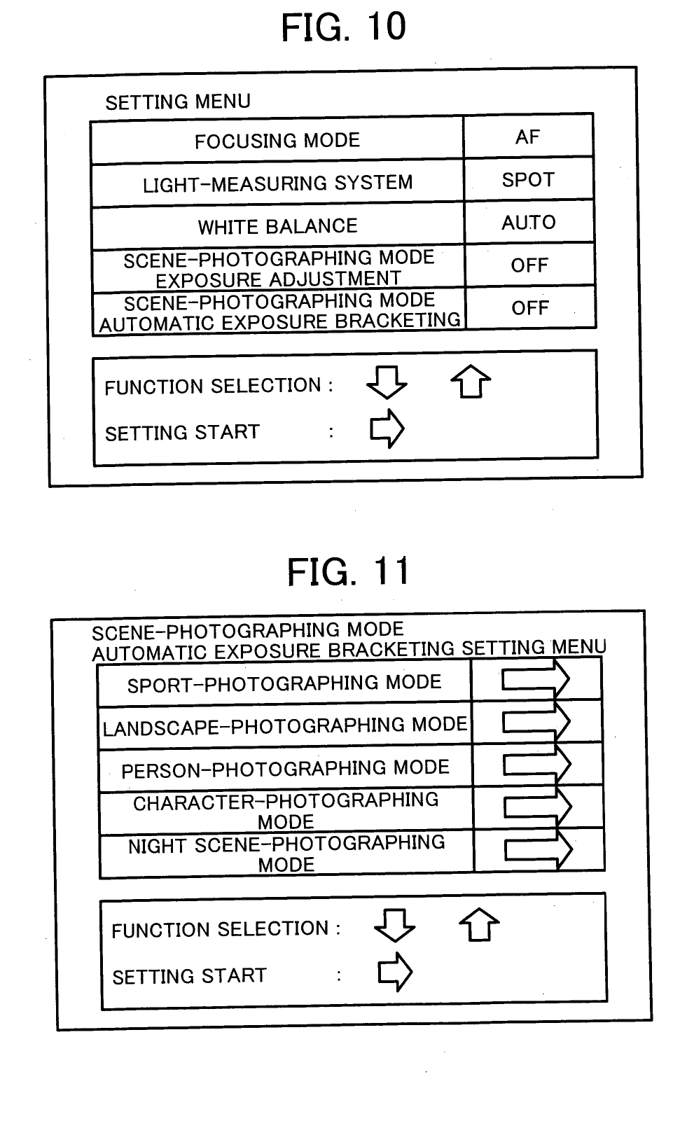

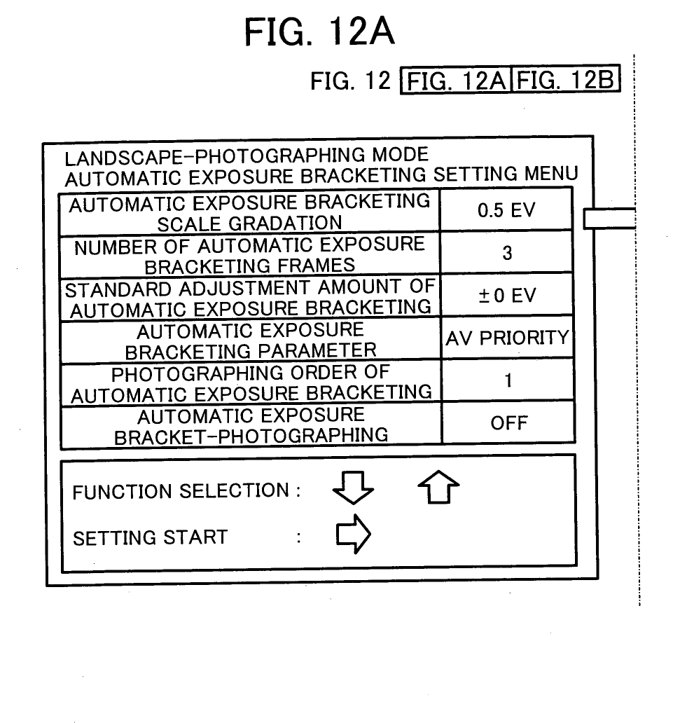

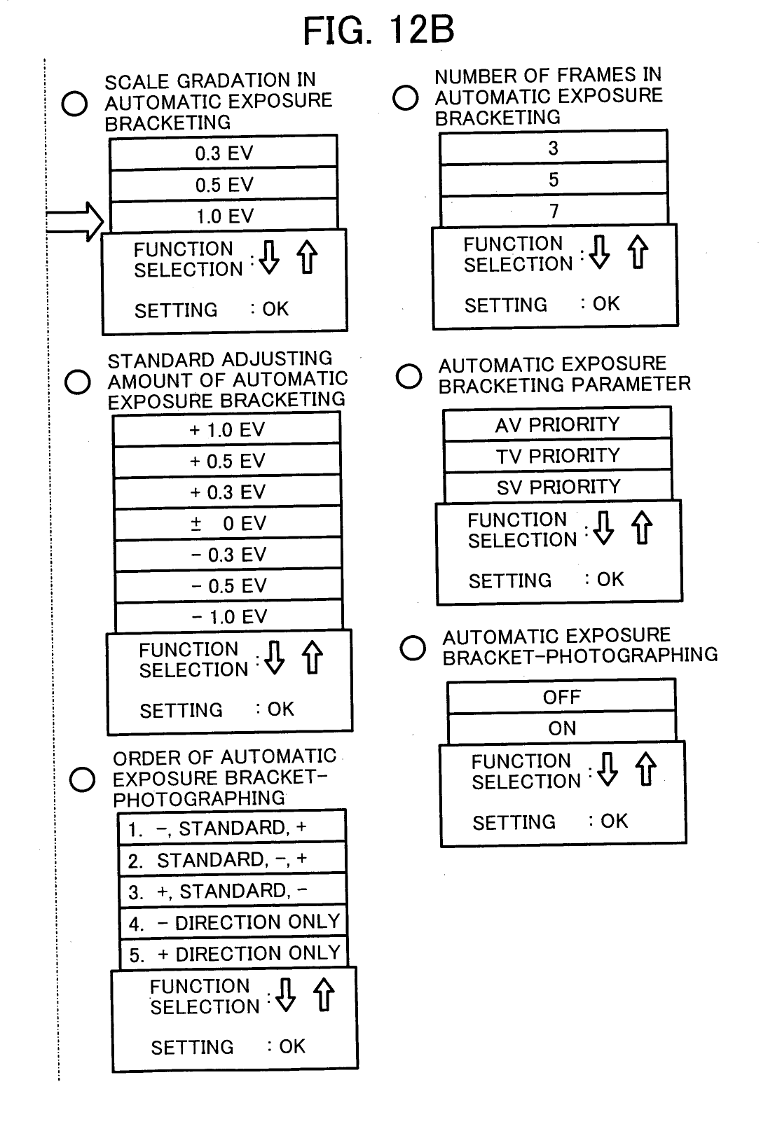

FIG. 10 is a view showing a first automatic exposure-setting screen every scene-photographing mode. FIG. 11 is a view showing a second automatic exposure-setting screen every scene-photographing mode. FIG. 12 is a view showing a third automatic exposure-setting screen every scene-photographing mode. The automatic exposure-setting method every scene-photographing mode will be explained by using FIGS. 10 to 12. FIG. 10 is the view showing the first automatic exposure-setting screen every scene-photographing mode. When the mode dial (SW2) of the external view of the camera in FIG. 1 is set to the setup position, the screen is displayed for setting camera operations shown in the automatic exposure-setting screen every scene-photographing mode in FIG. 10. Alternatively, that screen may be displayed by setting the dial (SW2) 3 to the photographing position and pushing down the menu switch (SW6) 16. When the scene-photographing mode automatic exposure is selected by using the upper strobe switch (SW7) 17 and the lower macroswitch (SW10)20 and the right switch (SW8) 18 in the external view of the camera in FIG. 3 is pushed down, the automatic exposure set screen every scene-photographing mode in FIG. 11 is displayed.

Next, the scene-photographing mode to be set is selected in the automatic exposure-setting screen every scene-photographing mode in FIG. 11 by using the upper strobe switch (SW7) 17 and the lower macroswitch (SW10) 20 in the external view of the camera in FIG. 3, and when the right switch (SW8) 18 is pushed down in the external view of the camera in FIG. 3, the automatic exposure-setting screen every scene-photographing mode in FIG. 12 is displayed.

Then, the currently set state in each set item is displayed in the automatic exposure-setting screen every scene-photographing mode in FIG. 11. Here, it is the same as in the case of the exposure adjustment-setting screen 2 every scene-photographing mode of FIG. 8 that if a user does not change the setting, it goes without saying that the initial value set by the maker is displayed.

Next, an item desired to be set is selected in the automatic exposure-setting screen every scene-photographing mode in FIG. 12 by using the upper strobe switch (SW7) 17 and the lower macroswitch (SW10) 20 in the external view of the camera in FIG. 3, and when the right switch (SW8) 18 is pushed down in the external view of the camera in FIG. 3, the set value for each set item shown in the right of the automatic exposure-setting screen every scene-photographing mode in FIG. 12 is displayed.

A desired set value is selected by using the upper strobe switch (SW7) 17 and the lower macroswitch (SW10) 20 in the external view of the camera in FIG. 3, and a desired set value is selected by pushing down the OK switch (SW12) 22 in the external view of the camera in FIG. 3.

An operation for returning the scene to the previous one on the way of setting the exposure adjustment every scene-photographing mode in FIGS. 7-9 and the automatic exposure bracket-photographing every scene-photographing mode in FIGS. 10-12 is effected by pushing down the menu switch (SW6) 16 in the external view of the camera in FIG. 3.

As having been explained, the image pickup apparatus of the present invention is useful for adjusting the exposure amount to an optimum level in the scene-photographing mode, and is suitable particularly for digital cameras which users not familiar with cameras use.

1. An image pickup apparatus comprising a scene-photographing mode selection switch configured for switchingly enable photographing suitable for a scene to be photographed, and an exposure adjuster configured for adjusting an exposure amount, wherein a scale graduation of an exposure-adjusting amounts to be adjusted by said exposure adjuster is adjustable independently for each of scene-photographing modes.

2. The image pickup apparatus set forth in claim 1, wherein said scale graduation of the exposure-adjusting amount is preliminarily set to an optimum scale graduation for each of the scene-photographing modes.

3. The image pickup apparatus set forth in claim 1, wherein said scale graduations of the exposure-adjusting amounts for the respective scene-photographing modes are set to be independently optimized.

4. The image pickup apparatus set forth in claim 1, wherein a parameter for varying the exposure amount is set to an optimum parameter for each of the scene-photographing modes.

5. The image pickup apparatus set forth in claim 2, wherein a parameter for varying the exposure amount is set to an optimum parameter for each of the scene-photographing modes.

6. The image pickup apparatus set forth in claim 3, wherein a parameter for varying the exposure amount is set to an optimum parameter for each of the scene-photographing modes.

7. The image pickup apparatus set forth in claim 4, wherein said parameter for varying the exposure amount is selected from a shutter speed, an aperture and a photographing sensitivity, and the setting of the parameter to the optimum one for each of the scene-photographing modes means that exposure is adjusted such that while at least one of the exposure amount-varying parameters is fixed, the other is adjusted.

8. The image pickup apparatus set forth in claim 5, wherein said parameter for varying the exposure amount is selected from a shutter speed, an aperture and a photographing sensitivity, and the setting of the parameter to the optimum one for each of the scene-photographing modes means that while exposure is adjusted such that at least one of the exposure amount-varying parameters is fixed, the other is adjusted.

9. The image pickup apparatus set forth in claim 6, wherein said parameter for varying the exposure amount is selected from a shutter speed, an aperture and a photographing sensitivity, and the setting of the parameter to the optimum one for each of the scene-photographing modes means that exposure is adjusted such that while at least one of the exposure amount-varying parameters is fixed, the other is adjusted.

10. An image pickup apparatus comprising a scene-photographing mode selection switch configured for switchingly enable photographing suitable for a scene to be photographed, and an exposure automatic exposure bracketing function effector configured for photographing a plurality of images while an exposure amount is being changed, wherein permission/inhibition of execution of the automatic exposure bracketing function effector is settable independently for scene-photographing modes.

11. The image pickup apparatus set forth in claim 10, wherein a set parameter of a automatic exposure bracketing function is preliminarily set to a premium parameter for each of the scene-photographing modes.

12. The image pickup apparatus set forth in claim 10, wherein the set parameter of a automatic exposure bracketing function can be optimized independently for each of the scene-photographing modes.

13. The image pickup apparatus set forth in claim 11, wherein the set parameter of the automatic exposure bracketing function is a scale graduation of the exposure-adjusting amount.

14. The image pickup apparatus set forth in claim 12, wherein the set parameter of the automatic exposure bracketing function is a scale graduation of the exposure-adjusting amount.

15. The image pickup apparatus set forth in claim 11, wherein said set parameter of the automatic exposure bracketing function is a number of frames to be photographed while the exposure amount is being changed.

16. The image pickup apparatus set forth in claim 12, wherein said set parameter of the automatic exposure bracketing function is a number of frames to be photographed while the exposure amount is being changed.

17. The image pickup apparatus set forth in claim 11, wherein said set parameter of the automatic exposure bracketing function is a standard exposure-adjusting amount.

18. The image pickup apparatus set forth in claim 12, wherein said set parameter of the automatic exposure bracketing function is a standard exposure-adjusting amount.

19. The image pickup apparatus set forth in claim 11, wherein said set parameter of the automatic exposure bracketing function is an order of exposure adjustments.

20. The image pickup apparatus set forth in claim 12, wherein said set parameter of the automatic exposure bracketing function is an order of exposure adjustments.

21. The image pickup apparatus set forth in 11, wherein said parameter for setting the automatic exposure bracketing function is the exposure amount-adjusting parameter, the exposure amount-adjusting parameter is selected from a shutter speed, an aperture and a photographing sensitivity, and exposure is adjusted such that while at least one of the exposure amount-changing parameters is fixed, the other is adjusted.

22. The image pickup apparatus set forth in 12, wherein said parameter for setting the automatic exposure bracketing function is the exposure amount-adjusting parameter, the exposure amount-adjusting parameter is selected from a shutter speed, an aperture and a photographing sensitivity, and exposure is adjusted such that while at least one of the exposure amount-changing parameters is fixed, the other is adjusted.
